(19) United States
(12) Patent Application Publication
(10) Pub. No.: US 2026/0359709 A1
(43) Pub. Date: Nov. 12, 2026

(54) EFFICIENT RETRIEVAL OF DOCUMENTS BASED ON GENERATED QUERIES

(71) Applicant: Zendesk, Inc., San Francisco, CA (US)

(72) Inventors: Mariana Sá Correia Leite de ALMEIDA, Lisbon (PT); Daniel Alexandre Bouçanova LOUREIRO, Riba de Ave (PT); Tiago Manuel Reis MESQUITA, Lisbon (PT)

(21) Appl. No.: 19/201,766

(22) Filed: May 7, 2025

(51) Int. Cl. G06N 20/00; G06Q 30/016

(52) U.S. Cl. CPC G06N 20/00; G06Q 30/016

(57) ABSTRACT

Certain aspects of the present disclosure provide a method for generating a plurality of synthetic queries to train a machine learning model as a dense retrieval model. The method includes generating text data relating to a plurality of documents; providing, to a first machine learning model, a prompt comprising: the text data; a first instruction to generate, based on one or more portions of the text data, one or more synthetic queries that are related to at least the first document; and a second instruction to generate metadata relating to the one or more synthetic queries, the metadata comprising information usable for training a second machine learning model; identifying, based on the metadata, at least a subset of the one or more synthetic queries for training the second machine learning model; and training the second machine learning model using at least the subset of the one or more synthetic queries.

### BACKGROUND

### Field

Aspects of the present disclosure relate to generating queries (e.g., synthetic queries) for training a machine learning model to function as, for example, a dense retrieval model.

### Description of Related Art

Numerous companies offer customer support in which, for example, a customer has an issue or request and reports it to a customer support team (including a number of customer support agents). The customer may report the issue or request using an appropriate channel, such as email or chat. These requests (sometimes referred to as “tickets”) can be of different types, such as issues with login, requests for information regarding an order, account deletion, etc. Preparing proper responses to these customer requests is a responsibility for the customer support agents of these companies. There are several challenges to preparing proper responses the customer requests, and these challenges are expected to affect more users (e.g., customers and customer support agents) as the prevalence and complexity of customer support systems grow.

### SUMMARY

One aspect of the present disclosure provides a method for generating a plurality of synthetic queries to train a machine learning model as a dense retrieval model. The method includes generating text data relating to a plurality of documents, wherein the text data include one or more of: a summary of at least a first document of the plurality of documents, one or more inferred questions relating to at least the first document, or one or more text chunks from at least the first document; providing, to a first machine learning model, a prompt including: the text data; a first instruction to generate, based on one or more portions of the text data, one or more synthetic queries that are related to at least the first document; and a second instruction to generate metadata relating to the one or more synthetic queries, the metadata including information usable for training a second machine learning model; identifying, based on the metadata, at least a subset of the one or more synthetic queries for training the second machine learning model; and training the second machine learning model using at least the subset of the one or more synthetic queries.

Other aspects provide processing systems configured to perform the aforementioned methods as well as those further described herein; non-transitory, computer-readable mediums comprising instructions that, when executed by one or more processors of a processing system, cause the processing system to perform the aforementioned methods as well as those further described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example system architecture for generating a plurality of synthetic queries to train a machine learning model as a dense retrieval model.

FIGS. 2A and 2B depict an example process flow for generating a plurality of synthetic queries to train a machine learning model as a dense retrieval model.

FIGS. 3A and 3B depict example process flows for generating a plurality of synthetic queries to train a machine learning model as a dense retrieval model.

FIG. 4A depicts an example prompt to provide to a first machine learning model to generate one or more questions for generating a plurality of synthetic queries to train a second machine learning model as a dense retrieval model.

FIG. 4B depicts an example prompt to provide to a first machine learning model to generate a summary for generating a plurality of synthetic queries to train a second machine learning model as a dense retrieval model.

FIG. 4C depicts an example prompt to provide to a first machine learning model to generate one or more synthetic queries to train a second machine learning model as a dense retrieval model.

FIG. 5A depicts an example representation of a generated question.

FIG. 5B depicts an example representation of a synthetic query for training a machine learning model as a dense retrieval model.

FIG. 6 depicts an example method for generating a plurality of synthetic queries to train a machine learning model as a dense retrieval model.

FIG. 7 depicts an example processing system with which aspects of the present disclosure can be performed.

FIG. 8 depicts an example prompt.

FIG. 9 depicts another example prompt.

FIG. 10 depicts another example prompt.

FIG. 11 depicts another example prompt.

FIG. 12 depicts another example prompt.

FIG. 13 depicts another example prompt.

FIG. 14 depicts another example prompt.

FIG. 15 depicts another example prompt.

FIG. 16 depicts another example prompt.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for generating a plurality of synthetic queries to train a machine learning model as a dense retrieval model.

As part of the process for addressing customer requests, customer support agents may provide, to customers, various documents (e.g., help center documents or articles) that include relevant information related to the customer requests. However, identifying the appropriate or relevant documents (e.g., matching the appropriate or relevant documents to the customer requests) requires a lot of time and resource (e.g., for the customer support agents to search for the appropriate or relevant documents, including the most relevant information corresponding to the customer requests). Thus, an improved solution to identifying the appropriate or relevant documents, including the most relevant information corresponding to the customer requests, is desired.

Some solutions exist for the problem of identifying the appropriate or relevant documents including relevant information related to the customer requests. One solution is to perform a keyword search of all available help center document or article titles, to identify the appropriate or relevant documents, and to have the customer support agents or a “bot” respond to the customer requests with the identified documents. While this solution provides some level of search to find the appropriate or relevant documents, this solution has several issues. For example, if a customer request is broad and related or applicable to many topics or contexts (e.g., related to how to request a refund, which may be relevant to documents including information related to returning an item at a physical store, returning an item by mail, refund policies, refund for lost items, etc.), a keyword search of relevant document or article titles would likely return more than a desired or practical number of documents as identified documents. Such search result would not be ideal for the customer, since the customer would need to review all of the identified documents to look for the most relevant information the customer needs, rather than being able to review just a select few (or one) to find the most relevant information. To mitigate this issue, the customer support agents may need to further review (e.g., manually) the identified documents to look for a desired or practical number of documents of the identified documents, to provide to the customer. The manual review of the identified documents may add unwanted delay in identifying the desired or practical number of documents, and may be prone to human error in identifying the correct documents (e.g., the most relevant documents).

Another solution is to train a machine learning model to identify the relevant help center documents or articles. Such a model may be referred to as an information retrieval model (e.g., a dense retrieval model). The dense retrieval model is a type of information retrieval model that uses dense vector embeddings to represent queries and documents, enabling a semantic search, where a dense vector embedding is a numerical representation of data (e.g., text data) where most or all elements of the vector are non-zero. The dense retrieval model is designated as “dense,” for example, in contrast to keyword-based information retrieval approaches, where keywords are matched in a “sparse” manner based on lexical features. Keyword-based information retrieval approaches are based on counting explicit (e.g., non-latent) lexical features shared between queries and documents. The dense retrieval model matches documents to queries, where the queries and the documents are not represented by explicit lexical features that can be counted. The queries and the documents are represented as points in a multi-dimensional latent space, learned automatically by the model, which encodes semantic features (e.g., non-explicit features). As points in this multi-dimensional latent space, the representations of the queries and the documents (e.g., embeddings or vectors) are dense (e.g., non-zero).

While the dense retrieval model may provide some level of search to find the appropriate or relevant documents to provide to a customer, this solution, without more, has several technical challenges. For example, preparing training data for the machine learning model may be expensive and/or limited by the amount of available training data. As but one example, training the machine learning model using real customer requests or tickets may be problematic because at least some of the real customer requests or tickets may include Personal Identifiable Information (PII) that may need to be removed before the real customer requests or tickets can be used as training data. Moreover, relying on the available real customer tickets or requests to train the machine learning model may not be ideal because, for example, the available real customer tickets or requests may not be comprehensive of the domain, and thus may impute potential biases related to how the customers identify any help center document or article to be helpful or relevant. For example, a customer may identify a first document of a group of suggested documents as the most helpful or relevant, without reviewing the other suggested documents, one or more of which may include even more helpful or relevant information. In some cases, certain help center document(s) or article(s) may be new and never shown to any customer, and the machine learning model may not be as well trained to match the new help center document(s) or article(s) to queries. In some cases, while certain off-the-shelf (e.g., pre-trained) dense retrieval models may be available, these models are not fine-tuned or optimized for specific use cases (e.g., a customer support system), and higher accuracy in information retrieval may be desired for such specific use cases.

Certain aspects described herein overcome the aforementioned technical challenges and problems by providing a solution to generate queries (e.g., synthetic queries) to use as training data for training a machine learning model. For example, the synthetic queries may be used as training data for training a machine learning model to function as a dense retrieval model. The solution described herein may be implemented by a customer support system that interacts with a first machine learning model to prepare training data, and thereafter trains a second machine learning model to identify suggested documents or articles relevant to customer requests. In certain aspects, the customer support system is configured to preprocess a plurality of help center documents to generate text data, which may be a summary, an inferred question, or an excerpt (e.g., one or more paragraphs or “chunks” of text), etc. The customer support system may then provide, to the first machine learning model, a prompt including an instruction to generate (i) a plurality of synthetic queries based on one or more portions of the generated text data, and (ii) one or more sets of metadata associated with one or more of the plurality of synthetic queries. In some aspects, the prompt specifies information related to the type of metadata to be generated and associated with the generated synthetic queries, including attribute data and/or query type data.

In certain aspects, the generation of the plurality of synthetic queries may be a two-step process. For example, a machine learning model may be prompted to generate a plurality of questions based on the plurality of help center documents (or portions of the documents). In some cases, these questions may correspond to inferred questions. Then, the machine learning model (or another machine learning model) may be prompted to generate the plurality of synthetic queries based on the generated plurality of questions. This technique further separates the generated synthetic queries from the help center documents, such that the generated synthetic queries may more effectively represent realistic queries (e.g., not based on answers to questions already included in the documents).

The output from the first machine learning model, which would include the plurality of synthetic queries and the associated metadata, may be used to generate the training data for training a second machine learning model to function as a dense retrieval model, such that appropriate or relevant documents may be retrieved in response to customer requests or tickets. The second machine learning model (e.g., the dense retrieval model), trained with the training data based on the plurality of synthetic queries and the associated metadata generated by the first machine learning model, provides the suggested documents or articles to a customer support agent or a bot, to provide to the customer. The solution described herein saves a considerable amount of time and resource that would otherwise be required to identify and retrieve the most relevant help center documents, by reducing the amount of time and effort required by any live customer support agent or any customer to review a greater than ideal number of help center documents, at least some of which may not include the most relevant information responsive to the customer requests. In some cases, the relevancy of retrieved documents (e.g., regarding specific use cases or services) may be improved when compared to documents that can be retrieved by generic off-the-shelf dense encoder models. Additionally, using synthetic queries to train a machine learning model allows for fine-tuning of models without using production (e.g., real) tickets, thereby protecting privacy of any PII that may be included in the production tickets.

In some cases, the dense retrieval model trained using the synthetic queries described herein may order documents or articles by relevance, and the output may be shown in a product as used in various use cases and used by various personas. One example use case may be a bot providing top K articles directly to an end user. In this example, the bot does not process more than the top K (e.g., top 3, top 5, top 10, or similar, depending on product features) to provide to the end user (e.g., directly or as part of a generated reply), thereby reducing compute resource usage and/or latency. Another example use case may be to provide an agent (e.g., a customer support agent) relevant content to answer a query, which improves the agent's productivity (e.g., in time, as the agent may not need to spend time to identify the relevant content). The documents or articles may be provided directly to the agent or as part of a generated reply. Another example use case may be to provide a document search engine to the end user, where the end user can review various ranked documents or articles (e.g., provided directly or as part of a generated reply, such as to a query).

Beneficially, the solution described herein may also process historical data related to real customer requests or tickets to further enhance the quality or reliability of the training data generated to train the second machine learning model. That is, using the synthetic queries as training data along with additional information, corresponding to the real customer requests or tickets, ensures that the second machine learning model is trained on not only the synthetic queries, but also on information related to the real customer requests or tickets. Examples of the information related to the real customer requests or tickets relate to how the synthetic queries in the training data should be constructed with respect to format (e.g., chat, email, etc.), tone or pattern of text (e.g., shorter requests-potentially from customers of a given industry, or more detailed or structured requests-potentially from customers of a different industry), data distribution (e.g., regarding the format or the tone or pattern of text), etc. The solution described herein therefore combines the best qualities of both synthetic queries and real-ticket-based information, in that it can use information related to the real customer requests or tickets without relying completely on the real-ticket-based information. Thus, any technical challenges associated with the real customer requests or tickets (e.g., a potential bias related to the suggested help center documents) is mitigated. Some aspects enable a better domain coverage for the training data, making the trained model more versatile and less biased by the user-based sample set. By enhancing the quality or reliability of the training data, certain aspects of the present disclosure improve the training process for training a machine learning model. For example, the solution described herein improves a machine learning model training process that results in an improved machine learning model—particularly, an improved dense retrieval model.

While certain aspects of the present disclosure have been described with respect to training a machine learning model to function as a dense retrieval model, these aspects may also apply generally for training a machine learning model to function as (or training) a retriever model, including a sparse retrieval model, consistent with this disclosure.

### Example System Architecture

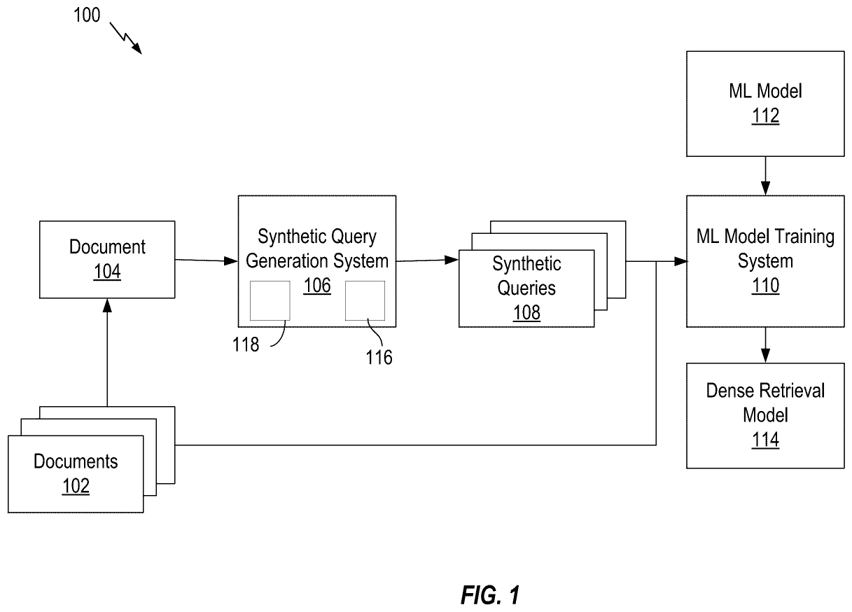

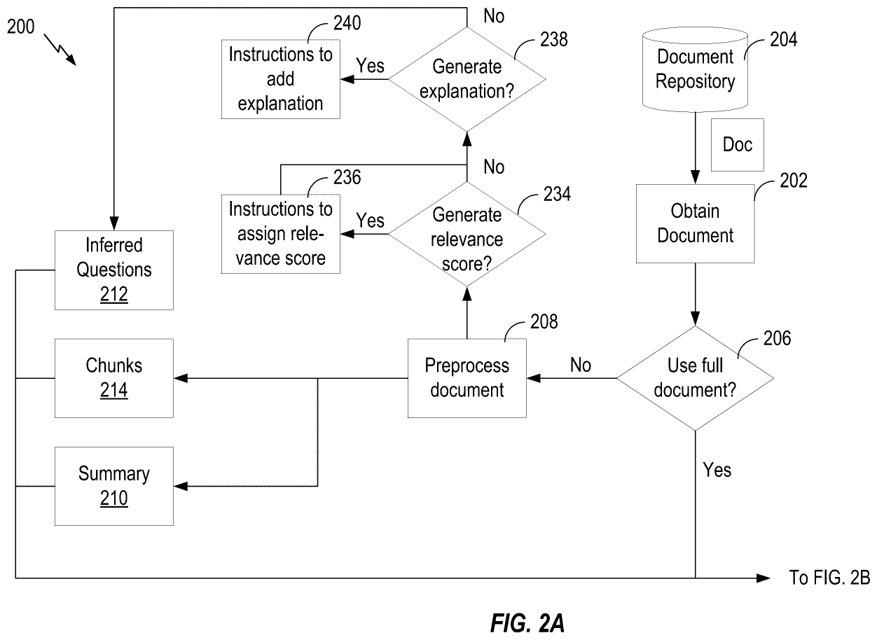

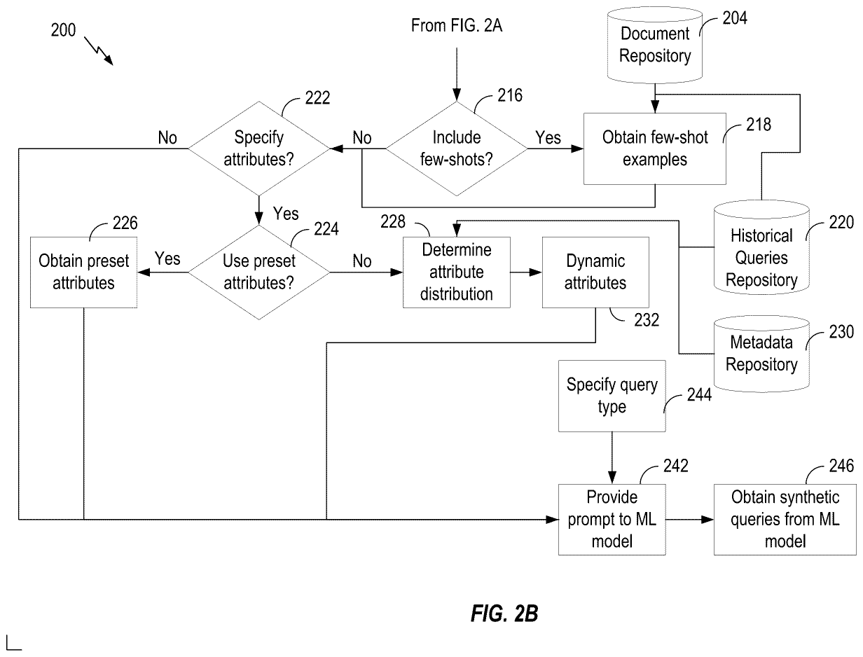

FIG. 1 depicts an example system architecture 100 for generating a plurality of synthetic queries to train a machine learning model as a dense retrieval model. As depicted, the system architecture 100 includes a synthetic query generation system 106 and a machine learning model training system 110. The synthetic query generation system 106 obtains a document 104 from a plurality of documents 102. The plurality of documents 102 may be stored in a data repository, and may include a plurality of help center documents that provide information related to various customer support services, such as related to login for a web service, requests for information regarding an order, account creation, account deletion, refund policies, etc. The synthetic query generation system 106 may obtain some or all of the plurality of documents 102, and iteratively generate one or more synthetic queries related to each of the plurality of documents 102. For example, the synthetic query generation system 106 may obtain all of the plurality of documents 102 and generate synthetic queries based on all of the plurality of documents 102, such as to prepare training data for training a machine learning model as a general information retrieval model that spans multiple issues or types of customer requests. As another example, the synthetic query generation system 106 may obtain some (e.g., not all) of the plurality of documents 102 that are specifically related to, for example, certain functions or industries, etc., such as to prepare training data for training a machine learning model as a specialized information retrieval model related to a specific industry (e.g., clothing stores, financial industry, etc.). As depicted, the synthetic query generation system 106 generates synthetic queries 108 based on the document 104. In the depicted example, the synthetic query generation system 106 includes a preprocessing component 116, which is described further herein with reference to FIG. 2A and FIG. 3B. Additional details regarding the generation of synthetic queries are described with reference to FIGS. 2A and 2B. In the depicted example, the synthetic query generation system 106 includes a prompt generation component 118, which is described further herein with reference to FIGS. 2A and 2B.

The machine learning model training system 110 obtains the synthetic queries 108 and trains a machine learning model 112 on the synthetic queries 108, to function as a dense retrieval model 114. For example, the machine learning model training system 110 may use a supervised learning algorithm to train the machine learning model 112. In some cases, the machine learning model 112 may already have been trained (e.g., pre-trained, such as on a generic training dataset) as a dense retrieval model, where the machine learning model training system 110 may fine-tune the machine learning model 112 for a specific use case, such as a customer support system. Supervised learning algorithms generally model relationships and dependencies between input features and target outputs. Supervised learning algorithms use labeled training data, which are data including one or more inputs (e.g., synthetic queries) and a desired output (e.g., one or more documents, such as help center documents, including relevant information related to the synthetic queries). Supervised learning may be used to train models to perform tasks like classification, where the goal is to predict discrete values. Some example supervised learning algorithms include nearest neighbor, naive Bayes, decision trees, linear regression, support vector machines (SVMs), and artificial neural networks (ANNs). In the example depicted in FIG. 1, the supervised learning use synthetic queries as labeled training data. For example, the synthetic queries may be stored as synthetic query data that include associated metadata, where the synthetic queries may be associated with one or more documents. Thus, the machine learning model training system 110 may perform the supervised learning algorithm using the synthetic query data, where the synthetic queries are inputs and the one or more documents are the desired output—labels. In certain cases, the machine learning model training system 110 uses input-and-output pairs (e.g., document-and-query pairs or text-and-query pairs, where the text may correspond to a portion of the document).

Though certain components are illustrated as separate components, the functionality of such components may be combined into a single component and/or further divided among additional components.

### Example Process Flows for Generating Synthetic Queries to Train a Machine Learning Model

FIGS. 2A and 2B depict an example process flow 200 for generating a plurality of synthetic queries to train a machine learning model as a dense retrieval model. The process flow 200 may generally be performed using the system architecture 100 of FIG. 1, such as by the synthetic query generation system 106.

Referring to FIG. 2A, the process flow 200 starts at 202 with obtaining a document from a document repository 204. The document repository 204 may be a storage device that stores (e.g., as part of a database) a plurality of documents, such as help center documents or articles. The help center documents or articles are to be matched to customer requests or tickets. In some cases, the document obtained at 202 may not be a full document. For example, one or more chunks (such as chunks 214 described below) may be obtained from the document repository 204 (e.g., by use of an application programming interface (API), etc.), to be processed as described below.

The process flow 200 continues at 206 with determining whether to use a full document (e.g., all of the document obtained at 202) or a portion of the document. If the full document is to be used, the process flow 200 continues to step 216 shown in FIG. 2B. Using the full document may correspond to a one-step process of generating synthetic queries, as depicted in FIG. 3A. If not all of the document is to be used, the process flow 200 continues to step 208. Not using the full document prevents the machine learning model from being trained on potential answers to certain questions in the document. For example, not using the full document prevents the machine learning model from generating queries that are specific to certain details included in the document (e.g., a help center document), which may not be realistic as a question coming from a real user requesting assistance. In some cases, the document may be split by defined sections (e.g., chunks) of the document. In certain cases, other methods of chunking may be possible. For example, while some sections or chunks may be used, certain other sections or chunks may not be used (e.g., based on whether the other sections or chunks may be too similar—by more than a threshold similarity level—to the sections or chunks already being used). In certain cases, the decision to use portions of documents (e.g., over summaries or inferred questions) may be based on the reduced dependency on a prompt request to generate the summaries or the inferred questions, thereby reducing hardware or operational cost and latency associated with performing the techniques described herein for generating high-volume training datasets.

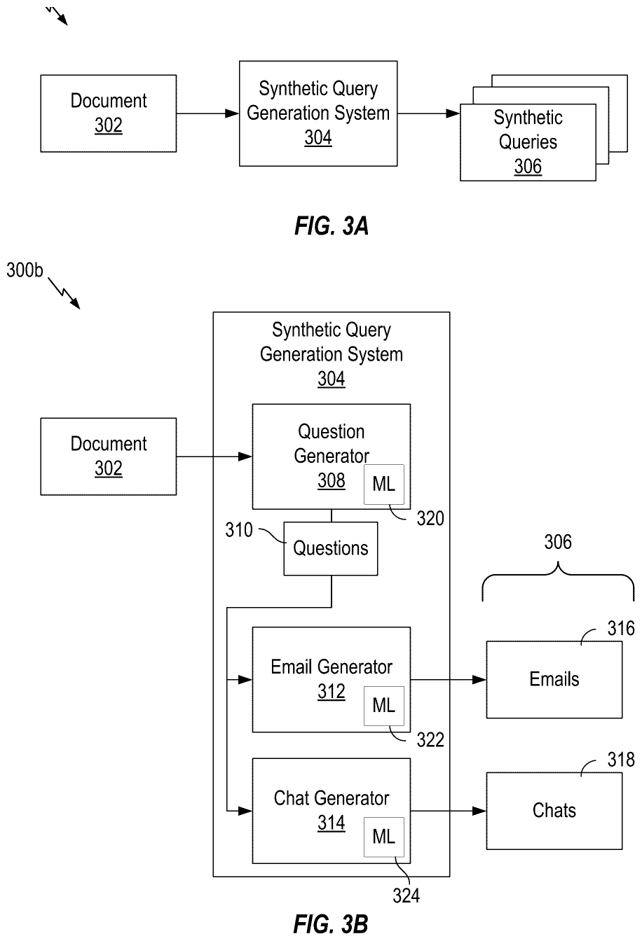

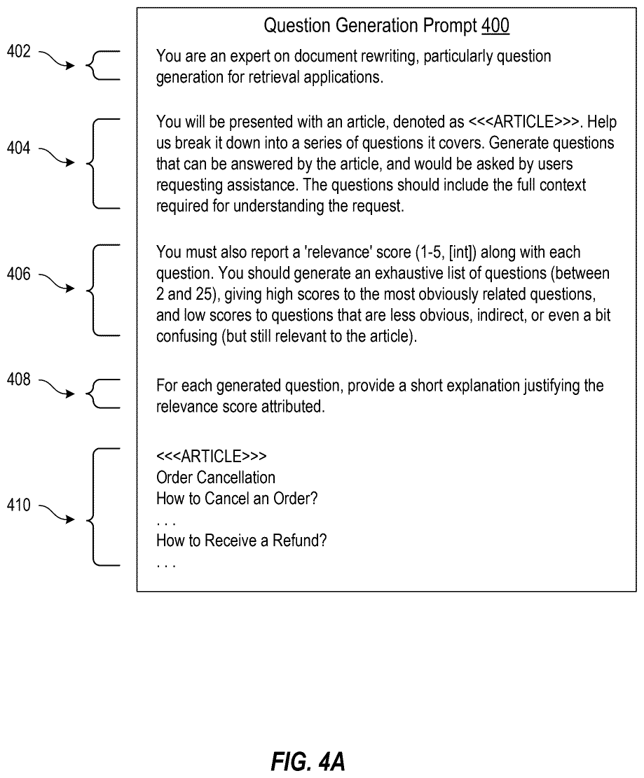

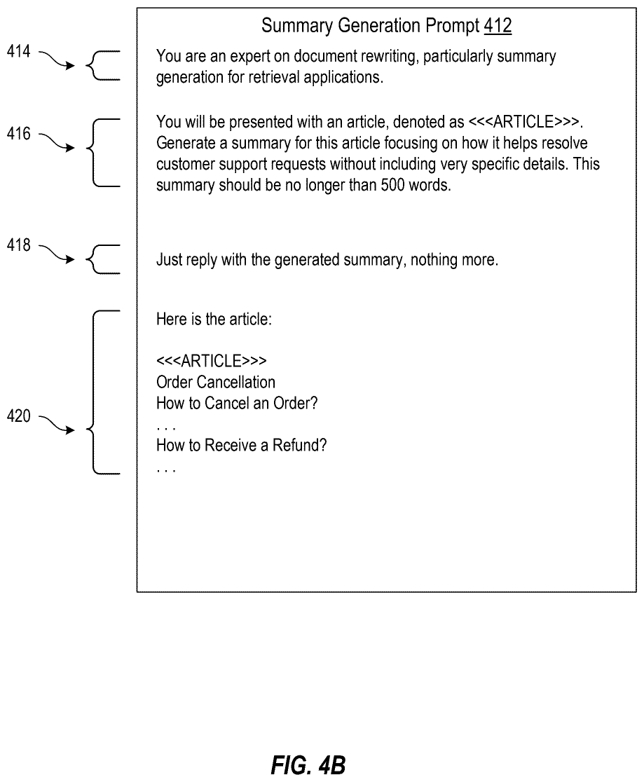

At 208, the process flow 200 continues with preprocessing the document (e.g., by a preprocessing component, such as the preprocessing component 116 of FIG. 1) to generate one or more of a summary 210, one or more inferred questions 212, or a plurality of chunks 214. In certain cases, the summary 210 may be an excerpt of the document, including text data from a portion of the document that may have a title indicating that the portion includes a summary. In some cases, the summary 210 may be generated, for example, using a machine learning model to generate the summary, such as a language model prompted to generate the summary (e.g., using a prompt depicted in FIG. 4B). Similarly, the one or more inferred questions 212 may be generated, for example, using a machine learning model, such as a language model prompted to generate the inferred questions (e.g., using a prompt depicted in FIG. 4A). For example, the preprocessing component may prompt the machine learning model with the document to generate questions based on the document, such as by asking the machine learning model to transform document section titles into questions (e.g., title: “Refund Policy” may be transformed into an inferred question: “what is your refund policy?”), or more generally by asking the machine learning model to generate questions that may be asked about the information included in the document. The preprocessing component may further generate a plurality of chunks of text based on the document. Chunks may refer to configured units of data, such as paragraphs of text, which may be obtained by breaking down the content of the document. As described above, using chunks of text included in the document (e.g., rather than using the full document) prevents the machine learning model from being trained on potential answers to certain questions in the document (which may be referred to as “unbiasing”). The unbiasing effect may be further realized when summaries or inferred questions (e.g., more abstract representations) are used.

With respect to the preprocessing step at 208 for generating the inferred questions 212, the process flow 200 continues at 234 with determining whether to include, in the prompt to a machine learning model for generating the inferred questions, an instruction to generate relevance scores for the inferred questions 212 to be generated. A relevance score may indicate how directly an inferred question is related to a document.

If relevance scores for the inferred questions 212 are to be generated (“yes” at 234), the process flow 200 continues at 236 with adding, in the prompt, the instruction to generate the relevance scores for the inferred questions 212 to be generated. For example, such instruction may be to report a relevance score (e.g., an integer from 1 to 5) along with each question to be generated, where higher scores may be assigned to questions that are more directly relevant to a document, and lower scores may be assigned to questions that are less directly related to the document. If relevance scores for the inferred questions 212 are not to be generated (“no” at 234), the process flow 200 continues at 238 described below. Generating the relevance scores promotes a higher diversity of questions (e.g., to be used for generating synthetic queries). For example, real customer queries may have varying levels of specificity, which may correspond to varying levels of relevance (e.g., to source articles). Additionally, the relevance scores may be considered for the training process (e.g., the confidence level on a document/text-and-query pair).

The process flow 200 continues at 238 with determining whether to include, in the prompt, an instruction to generate an explanation for the inferred questions 212 to be generated. The explanation may indicate the “thought process” (e.g., steps performed) by which a model may generate a question related to a document. An example of such explanation may be “This document describes a refund policy. A user may have a question about the refund policy. The question may be ‘How do I receive a refund?’” for the question of “How do I receive a refund?”

If an explanation for the questions is to be generated (“yes” at 238), the process flow 200 continues at 240 with adding, in the prompt, the instruction to generate the explanation for the questions to be generated. If no explanation for the questions is to be generated (“no” at 238), the process flow 200 continues at 216 described below, after generating the inferred questions 212.

Preprocessing the document may provide certain technical advantages or benefits. For example, as the preprocessing allows (e.g., only) certain portions of the document, rather than all of the document, to be used to prepare synthetic queries, the synthetic queries that are generated in this manner may be more aligned with real customer requests or tickets. The real customer requests or tickets are typically received by a customer support system because a customer does not know an answer to a question. The document potentially includes the information that may answer the customer's question. The preprocessing allows certain portions of the document to not be used for generating the synthetic queries. Such portions may include the answer to the customer's question, and not using these portions prevent the machine learning model from being trained on potential answers to certain questions in the document, thereby increasing the unbiasing effect described above.

In some cases, the preprocessing may also include a process to remove any PII that may be used for generating the synthetic queries, thereby preventing the PII from being used for any training or inference. For example, the preprocessing may identify PII in a document (e.g., based on text or number format, etc.) and replace the PII with placeholder characters, such as when the document may be expected to include PII. By identifying and removing the PII from the document based on which synthetic queries may be generated (or on which the preprocessing described above may be performed), the solution described herein may be made compliant with relevant law, regulations, and/or policies.

With respect to a two-step process of generating synthetic queries described herein with reference to FIG. 3B, the steps described above with respect to FIG. 2A may correspond to the first step of generating, for example, inferred questions.

Referring now to FIG. 2B, the process flow 200 continues with steps that may generally be performed by, for example, the prompt generation component 118 of FIG. 1 for generating synthetic queries.

The process flow 200 continues at 216 with determining whether to include few-shot query examples in a prompt for generating synthetic queries. The few-shot query examples refer to a few (e.g., 2 to 5 or more) examples of input-and-output pairs (e.g., document-and-query pairs or text-and-query pairs, where the text may correspond to a portion of the document, such as a summary or a chunk, or an inferred question). In certain cases, the document or text may not be paired with a query, where the query examples may be included to induce the machine learning model to generate synthetic queries (e.g., emails, chats, or similar) that implicitly feature similar query attributes that can be observed in a specific customer's production or real tickets. These examples provide a machine learning model with a set of demonstrations to help it understand the desired input-and-output relationship.

To include the few-shot query examples in the prompt (“yes” at 216), the process flow 200 continues at 218 with obtaining the few-shot query examples from the document repository 204 and a historical queries repository 220 and including the few-shot query examples in the prompt. The historical queries repository 220 may be a storage device that stores (e.g., as part of a database) a plurality of historical queries (e.g., real queries relating to real historical customer request or tickets). If the few-shot query examples are not to be included (“no” at 216), the process flow 200 continues at 222 described below.

The process flow 200 continues at 222 with determining whether to specify, in the prompt, attributes for the synthetic queries to be generated. In certain aspects, the attributes may be related to stylistic aspects of the synthetic queries to be generated as well as semantic content of the synthetic queries to be generated. For example, the stylistic aspects may be related to whether the synthetic queries will be formal or informal, or short or long. The semantic content may be related to whether the synthetic queries will be clear or confusing, as an example. Additional examples of the attributes may be related to tone (e.g., casual or professional), format (e.g., to include a greeting or signature, etc.), etc.

If attributes are to be specified (“yes” at 222), the process flow 200 continues at 224 with determining whether to use preset (e.g., predefined) attributes. The present attributes may include one or more attributes that may be consistently applied to all synthetic queries to be generated (e.g., without regard to types or groups of documents, customer base, relevant industry or knowledge domain, etc.). The preset attributes can be randomly selected from a general set of attributes, or randomly selected from a subset of the general set of attributes (e.g., an industry-specific set of attributes). If attributes are not to be specified (“no” at 222), the process flow 200 continues at 242 described below.

If preset attributes are to be used (“yes” at 224), the process flow 200 continues at 226 with obtaining (e.g., from a data storage device accessible by the prompt generation component 118) the preset attributes and adding an indication of the preset attributes to the prompt. After 226, the process flow 200 continues at 242 described below.

If preset attributes are not to be used (“no” at 224), the process flow 200 continues at 228 with determining an attribute distribution to apply. The attribute distribution may refer to a distribution of how many or which group of synthetic queries would have certain attributes, such as a first percentage of the synthetic queries having a first attribute, a second percentage of the synthetic queries having a second attribute, etc. For example, the attribute distribution to apply may be based on an existing or known attribute distribution that may be found in historical queries (e.g., all of the historical queries, a subset of the historical queries such as related to a specific type or group of documents, a specific customer base, a specific industry or knowledge domain, etc.) from the historical queries repository 220 and a metadata repository 230 that stores metadata (e.g., attributes) related to the historical queries stored in the historical queries repository 220. Step 242 described below discusses how the metadata may be generated. In certain aspects, the same attribute distribution from the historical queries may be specified in the prompt for generating the synthetic queries. For example, such attribute distribution may be applicable to a target type or group of documents, customer base, industry, or knowledge domain (or more generally, all of the historical queries) for training a machine learning model for information retrieval, Thus, if an attribute distribution is specified in the prompt, the synthetic queries to be generated will have the same or similar attribute distribution as the specified attribute distribution.

To use dynamic attributes (e.g., based on the attribute distribution determined at 228), the process flow 200 continues at 232 with adding an instruction in the prompt to use the dynamic attributes that are based on the attribute distribution determined at 228.

The process flow 200 continues at 242 with providing the prompt, as constructed based on at least some of the previous steps of the process flow 200, to a machine learning model to generate the synthetic queries to use as training data for training another machine learning model (e.g., another untrained model) to function as a dense retrieval model. In certain cases, at least a subset of the historical queries from the historical queries repository 220 may be used as part of the training data (along with the synthetic queries) for training the other machine learning model to function as the dense retrieval model. The added training data may allow the trained model to be more robust in the model's information or document retrieval capabilities.

As depicted in FIG. 2B, the process flow 200 includes step 244 to specify, in the prompt, a query type for the synthetic queries to be generated. Examples of the query type include email, chat, etc. As described further herein, generating the synthetic queries in a two-step process (e.g., first prompting a machine learning model to generate questions (or similarly, summaries), and then prompting a machine learning model to generate the synthetic queries based on the generated questions) may provide certain technical benefits when compared to generating the synthetic queries in a one-step process (e.g., without the preprocessing steps described above). For example, the two-step process further separates the generated synthetic queries from the help center documents, such that the generated synthetic queries may more effectively represent realistic queries (e.g., not based on answers to questions already included in the documents).

The process flow 200 continues at 246 with obtaining, from the prompted machine learning model, a plurality of synthetic queries related to a document (e.g., generated based on the inferred questions, summary, or chunks of the document) to use as training data for training a machine learning model to function as a dense retrieval model.

In certain aspects, the prompt at 242 may further include an instruction to generate metadata relating to the synthetic queries to be generated. For example, the metadata to be generated may include information usable for training a machine learning model to function as a dense retrieval model (e.g., query attributes, etc.). In certain cases, the generated metadata may be stored in the metadata repository 230, and may be used for, for example, parts of the process flow 200 (e.g., for determining an attribute distribution to apply, etc.) or identifying a subset of the synthetic queries for training a machine learning model (e.g., to train the machine learning model for a specific customer base, a specific target industry, knowledge domain, etc.). Thus, depending on the target purpose (e.g., target customer base, industry, knowledge domain, etc.), the machine learning model may be trained using a given subset of the generated synthetic queries. In some cases, the obtained synthetic queries may be processed (e.g., preprocessed) before being used to train a machine learning model, such as to remove any PII that may be present, thereby preventing any PII from being used for training or inference.

Note that FIGS. 2A and 2B depict just one example of a process flow, and other flows including fewer, additional, or alternative operations are possible consistent with this disclosure. For example, while various parts of FIGS. 2A and 2B as depicted and described as being part of the process flow 200 as one flow, in some aspects, certain parts of the process flow 200 may be an example of a first step of a two-step process for generating synthetic queries (e.g., to generate questions, summaries, or chunks, as described with respect to step 208), and other parts of the process flow 200 may be an example of a second step of the two-step process (e.g., to generate synthetic queries based on the generated questions, summaries, or chunks).

### Example Process Flows for Generating Synthetic Queries

Referring now to FIGS. 3A and 3B, example process flows 300a and 300b for generating a plurality of synthetic queries to train a machine learning model as a dense retrieval model are depicted.

Process flow 300a of FIG. 3A depicts a flow where synthetic query generation system 304 generates synthetic queries 306 (e.g., as emails, chats, or similar), directly, based on document 302 (e.g., without the preprocessing steps described with respect to FIG. 2A). Thus, the process flow 300a may follow the same or similar steps as described herein with reference to the process flow 200 of FIGS. 2A and 2B, where it would be determined at 206 to use a full document.

Process flow 300b of FIG. 3B depicts a flow where, to generate the synthetic queries 306 related to the document 302, the synthetic query generation system 304 first generates questions 310 (e.g., inferred questions 212 of FIG. 2A) that are then used to transform the questions 310 into queries of different types (e.g., emails 316 or chats 318), such as per the input at 244 of FIG. 2B. As depicted, in certain aspects, the synthetic query generation system 304 includes a question generator 308, an email generator 312, and a chat generator 314. The question generator 308 generates the questions 310 by following, at least in part, the process flow 200 described with respect to FIG. 2A. For example, the question generator 308 may prompt a machine learning model 320 to generate the questions 310. Then, the email generator 312 and/or the chat generator 314 prompts a machine learning model 322, 324 to generate the emails 316 and/or the chats 318 based on the questions 310. In certain cases, the machine learning model 322, 324 prompted by the email generator 312 and the chat generator 314 may be the same machine learning model as the machine learning model 320 prompted by the question generator 308 or the machine learning model prompted to generate the synthetic queries as described with reference to the process flow 200 of FIGS. 2A and 2B. In some cases, the machine learning model 320, 322, 324 may be a language model, such as a large language model (LLM).

Note that the email generator 312 and the chat generator 314 are examples of a generator for generating a synthetic query of a specific query type. Other types of generators (e.g., for generating synthetic queries of other query types) are also possible consistent with this disclosure.

### Example Prompts

FIGS. 4A, 4B, and 4C depict examples of prompts described herein with respect to FIGS. 2A, 2B, and 3B. In certain cases, the example prompts depicted in FIGS. 4A, 4B, and 4C may be used as part of a two-step process to generate synthetic queries, as described with respect to FIG. 3B.

Referring to FIG. 4A, a question generation prompt 400 includes a persona indication 402. As depicted, one example of indicating the persona for a machine learning model is to indicate that the model is “an expert on document rewriting, particularly question generation for retrieval applications.” In certain aspects, the question generation prompt 400 may be used to generate an inferred question, such as the inferred question 212 described with respect to FIG. 2A.

The question generation prompt 400 also includes context information 404. As depicted, one example of the context information that can be provided for prompting a machine learning to generate questions (e.g., inferred questions) is to indicate: “You will be presented with an article, denoted as <<<ARTICLE>>>. Help us break it down into a series of questions it covers. Generate questions that can be answered by the article, and would be asked by users requesting assistance. The questions should include the full context required for understanding the request.”

The question generation prompt 400 of FIG. 4A further includes a relevance score instruction 406. For example, the relevance score instruction 406 may correspond to the instruction added at 236 of the process flow 200 described with respect to FIG. 2A.

The question generation prompt 400 of FIG. 4A also includes an explanation instruction 408. For example, the explanation instruction 408 may correspond to the instruction added at 240 of the process flow 200 described with respect to FIG. 2A.

In certain cases, the relevance score instruction 406 and the explanation instruction 408, if added, may be used to prompt a machine learning model to generate a range of varying questions, such as associated with varying relevance scores.

The question generation prompt 400 further includes an indication of document 410. For example, the indication of document 410 may be a document name, a link to where the document is stored, etc. In some cases, as depicted in FIG. 4A, the content of the document may be included as part of the indication of document 410. In some cases, the indication of document 410 may correspond to a full document or a portion of a document (e.g., one or more chunks).

FIG. 4B depicts a summary generation prompt 412. The summary generation prompt 412 may be used to generate a summary of a document, such as the summary 210 of FIG. 2A. As depicted, the summary generation prompt 412 includes a persona indication 414, a context information 416, and an indication of document 420 (similar to, respectively, the persona indication 402, the context information 404, and the indication of document 410 of FIG. 4A).

The summary generation prompt 412 also includes an instruction 418, such as to indicate what the output should be (e.g., and in what format, etc.).

FIG. 4C depicts a query generation prompt 422. The query generation prompt 422 may be used to generate a synthetic query (e.g., based on a generated question or summary, such as generated based on the question generation prompt 400 or the summary generation prompt 412 described above). The generated synthetic query may be an example of the synthetic queries 108 of FIG. 1 or the synthetic queries 306 of FIG. 3B. As depicted, the query generation prompt 422 includes a persona indication 424 and a context information 426 (similar to, respectively, the persona indication 402 and the context information 404 of FIG. 4A or the persona indication 414 and the context information 416 of FIG. 4B).

The query generation prompt 422 depicted in FIG. 4C also includes attributes 428. For example, the attributes 428 may correspond to the attributes described herein with reference to steps 222, 224, 226, 228, and 232 of the process flow 200 described with respect to FIG. 2B.

The query generation prompt 422 includes few-shot query examples 430. For example, the few-shot query examples 430 may correspond to the few-shot query examples that are obtained at 218 of the process flow 200 described with respect to FIG. 2B.

The query generation prompt 422 further includes an indication of question 432. For example, the indication of question 432 may be a question identifier, a link to where the question is stored, etc. In some cases, as depicted in FIG. 4C, the content of the question may be included as part of the indication of question 432.

Note that the question generation prompt 400, the summary generation prompt 412, and the query generation prompt 422 of FIGS. 4A, 4B, and 4C are just examples of the prompts that are described herein as being provided to a machine learning model for generating inferred questions, a summary, and synthetic queries, and other prompts including fewer, additional, or alternative components (e.g., in accordance with the process flow 200 of FIGS. 2A and 2B and/or the process flows 300a, 300b of FIGS. 3A and 3B) are possible consistent with this disclosure.

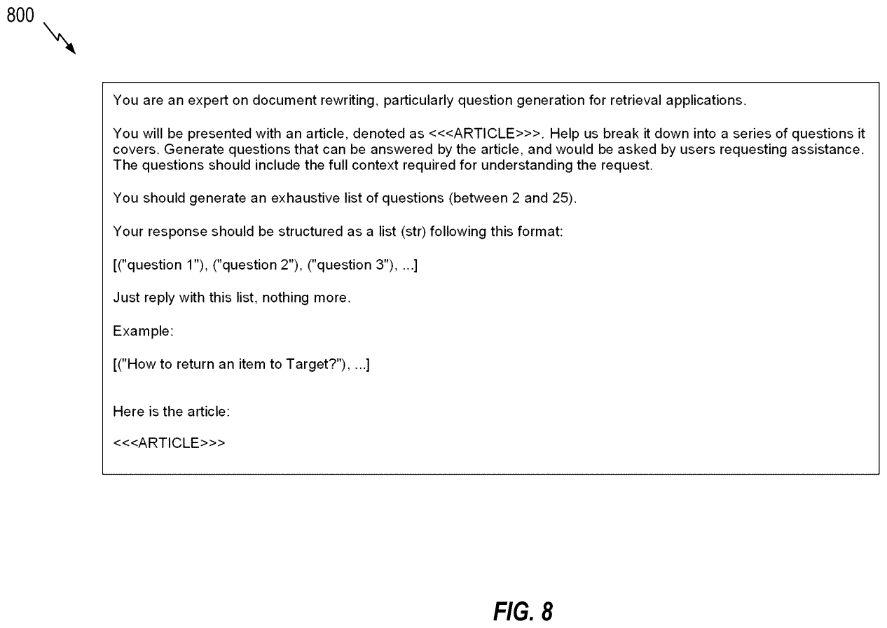

For example, FIG. 8 depicts a prompt 800, as an example of a prompt for question generation. The prompt 800 uses an input of an article (e.g., a help center document) and is used for generating a plurality of questions (e.g., inferred questions, such as inferred questions 212 described herein with reference to FIG. 2A). The prompt 800 depicted in FIG. 8 does not prompt the model to generate any other output, such as any relevance score or explanation.

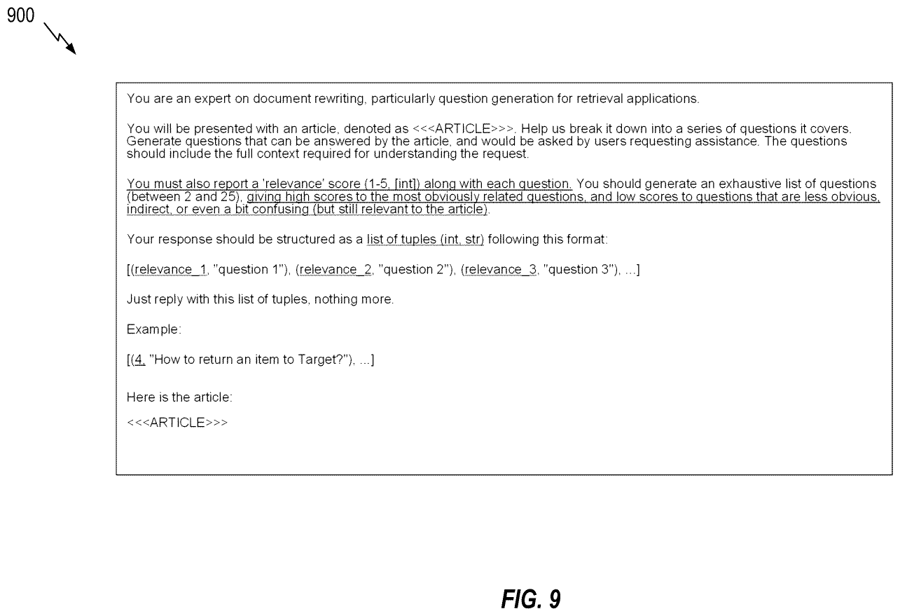

FIG. 9 depicts a prompt 900, as another example of a prompt for question generation. The prompt 900 includes an instruction to generate relevance scores (e.g., as described with reference to step 236 of the process flow 200 described with respect to FIG. 2A). The underlined portions of the prompt 900 include changes relative to the prompt 800 of FIG. 8.

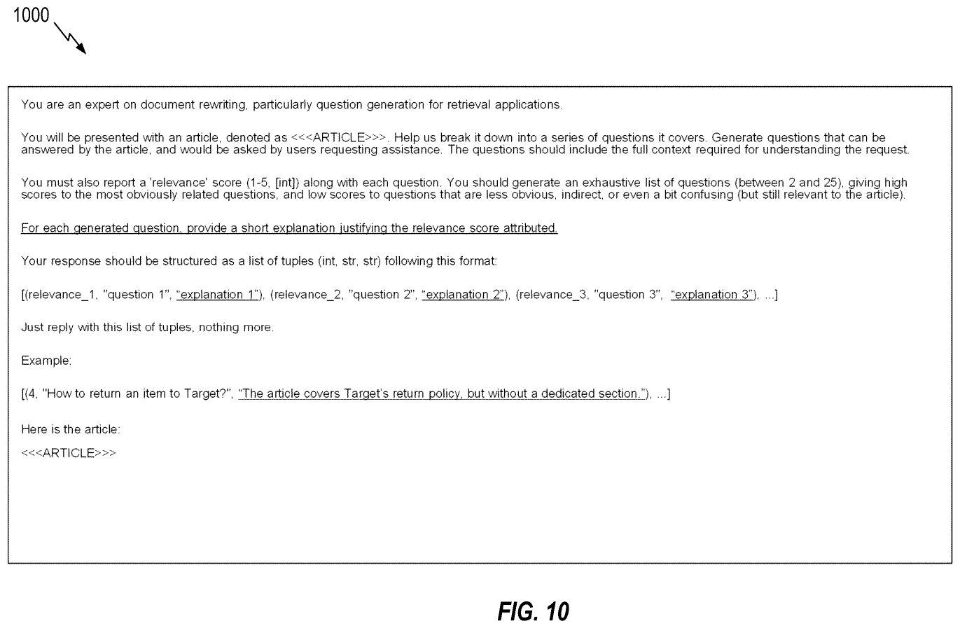

FIG. 10 depicts a prompt 1000, as another example of a prompt for question generation. The prompt 1000 includes an instruction to generate explanations (e.g., as described with reference to step 240 of the process flow 200 described with respect to FIG. 2A). The underlined portions of the prompt 1000 include changes relative to the prompt 900 of FIG. 9.

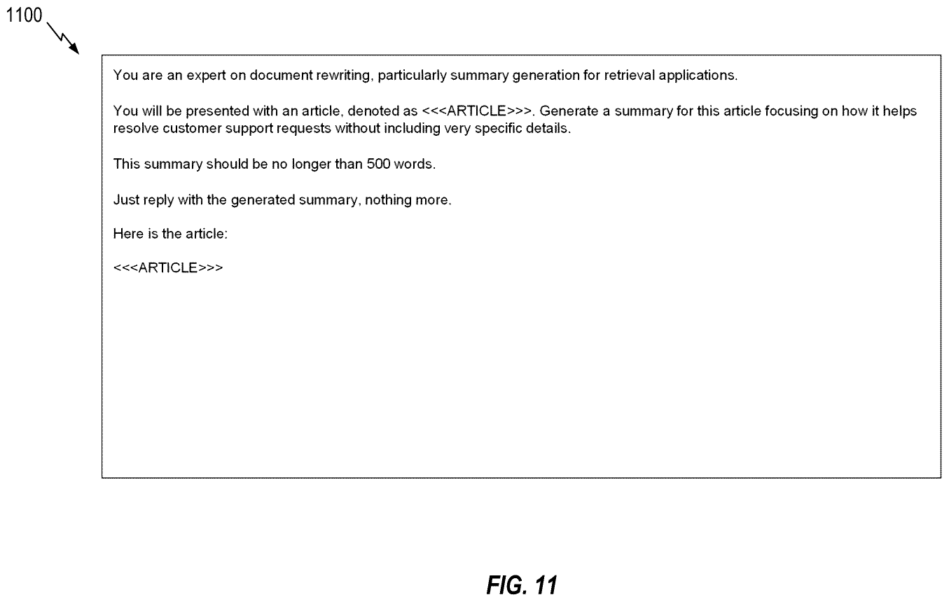

FIG. 11 depicts a prompt 1100, as an example of a prompt for summary generation. The prompt 1100 uses an input of an article (e.g., a help center document) and is used for generating a summary (e.g., summary 210 described herein with reference to FIG. 2A).

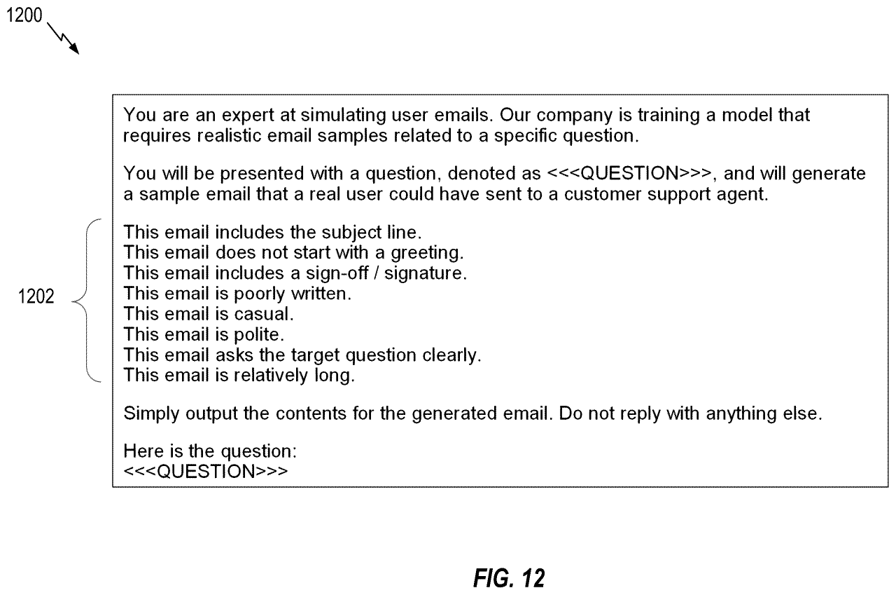

FIG. 12 depicts a prompt 1200, as an example of a prompt for query generation. The prompt 1200 uses an input of a question (e.g., as generated based on the prompt 800 of FIG. 8, the prompt 900 of FIG. 9, or the prompt 1000 of FIG. 10) and is used for generating a synthetic query (e.g., as part of the two-step process depicted in FIG. 3B). The prompt 1200 includes a plurality of attributes 1202 to be used for the synthetic query to be generated. The plurality of attributes 1202 may include preset attributes and/or dynamic attributes (e.g., based on an attribute distribution) as described herein with reference to FIG. 2B. In certain cases, the plurality of attributes 1202 may be included in the prompt 1200 in the same manner (e.g., as depicted in FIG. 12) regardless of how they are selected (e.g., from preset attributes, from historical queries, randomly selected, etc.).

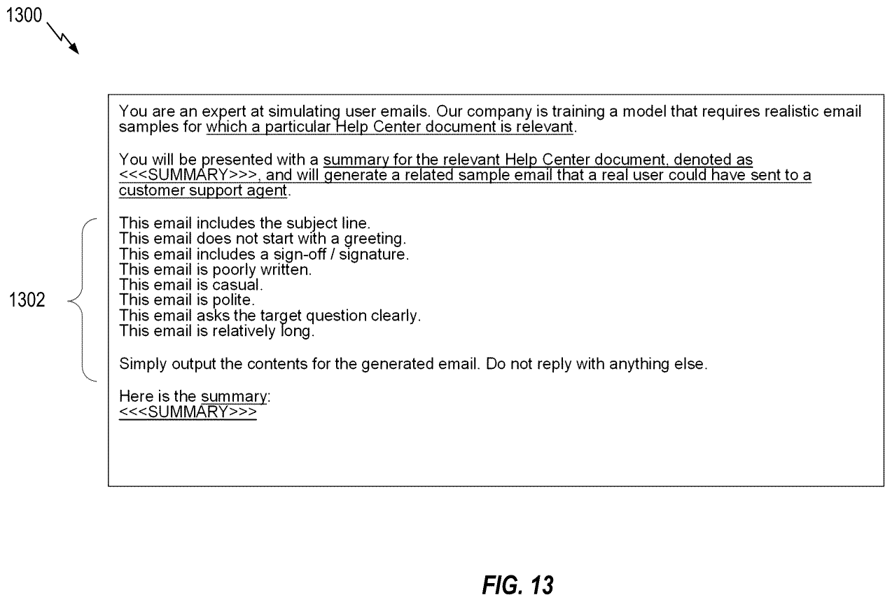

FIG. 13 depicts a prompt 1300, as another example of a prompt for query generation. The prompt 1300 uses an input of a summary (e.g., as generated based on the prompt 1100 of FIG. 11) and is used for generating a synthetic query (e.g., as part of the two-step process depicted in FIG. 3B). The prompt 1300 includes a plurality of attributes 1302 to be used for the synthetic query to be generated. The plurality of attributes 1302 may include preset attributes and/or dynamic attributes (e.g., based on an attribute distribution) as described herein with reference to FIG. 2B. In certain cases, the plurality of attributes 1302 may be included in the prompt 1300 in a same manner (e.g., as depicted in FIG. 13) regardless of how they are selected (e.g., from preset attributes, from historical queries, randomly selected, etc.). The underlined portions of the prompt 1300 include changes relative to the prompt 1200 of FIG. 12.

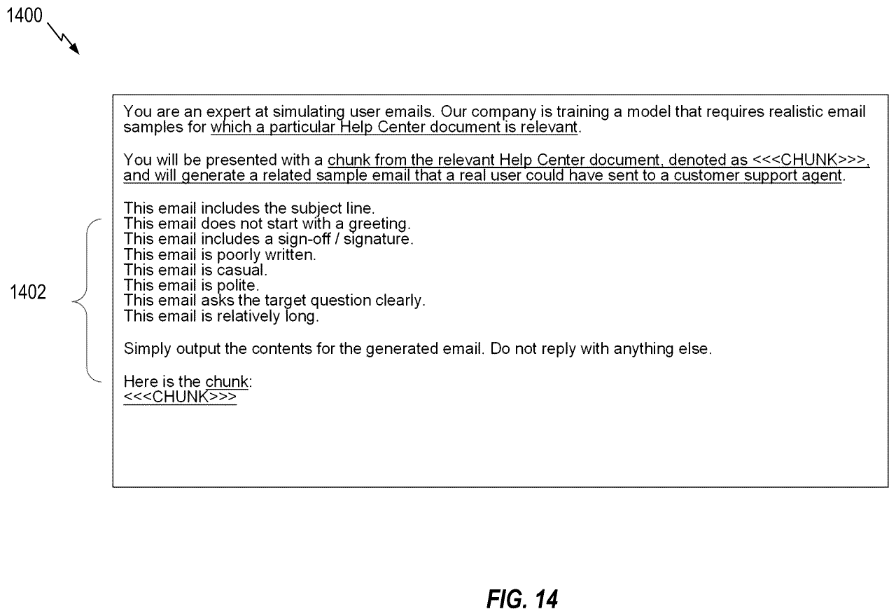

FIG. 14 depicts a prompt 1400, as another example of a prompt for query generation. The prompt 1400 uses an input of a chunk (e.g., chunks 214 described herein with reference to FIG. 2A) and is used for generating a synthetic query (e.g., as part of the two-step process depicted in FIG. 3B). The prompt 1400 includes a plurality of attributes 1402 to be used for the synthetic query to be generated. The plurality of attributes 1402 may include preset attributes and/or dynamic attributes (e.g., based on an attribute distribution) as described herein with reference to FIG. 2B. In certain cases, the plurality of attributes 1402 may be included in the prompt 1400 in a same manner (e.g., as depicted in FIG. 14) regardless of how they are selected (e.g., from preset attributes, from historical queries, randomly selected, etc.). The underlined portions of the prompt 1400 include changes relative to the prompt 1200 of FIG. 12.

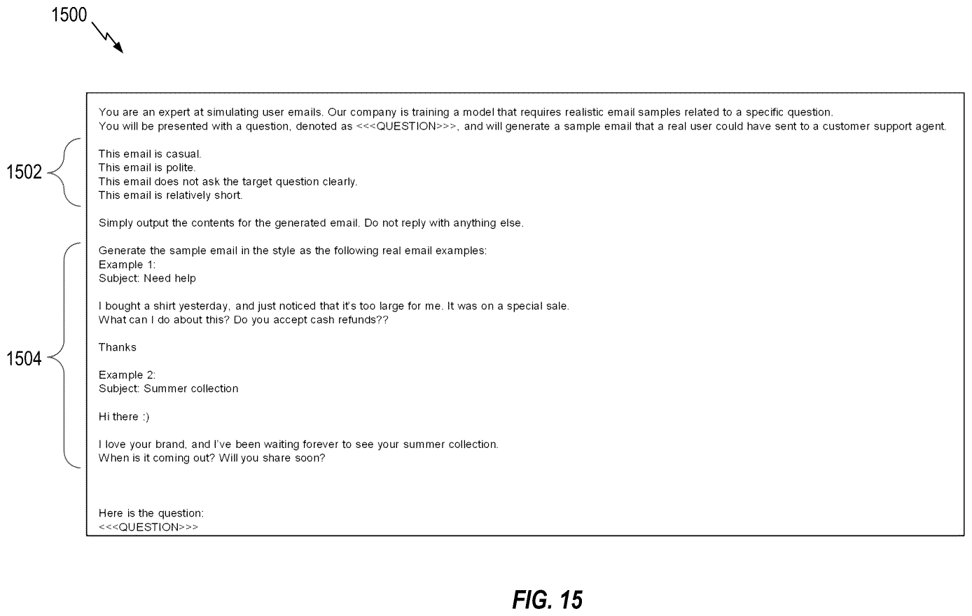

FIG. 15 depicts a prompt 1500, as another example of a prompt for query generation. The prompt 1500 uses an input of a question (e.g., as generated based on the prompt 800 of FIG. 8, the prompt 900 of FIG. 9, or the prompt 1000 of FIG. 10) and is used for generating a synthetic query (e.g., as part of the two-step process depicted in FIG. 3B). The prompt 1500 includes a plurality of attributes 1502 and a plurality of few-shot query examples 1504 to be used for the synthetic query to be generated. The plurality of attributes 1502 may include preset attributes and/or dynamic attributes (e.g., based on an attribute distribution) as described herein with reference to FIG. 2B. In certain cases, the plurality of attributes 1502 may be included in the prompt 1500 in the same manner (e.g., as depicted in FIG. 15) regardless of how they are selected (e.g., from preset attributes, from historical queries, randomly selected, etc.). The plurality of few-shot query examples 1504 are examples of queries that can be generated. In certain cases, the plurality of few-shot query examples 1504 may be consistent with the plurality of attributes 1502. In some cases, the plurality of few-shot query examples 1504 may not be consistent with the plurality of attributes 1502, where the plurality of few-shot query examples 1504 may serve as an example of the format of a requested query type (e.g., an email in the depicted example).

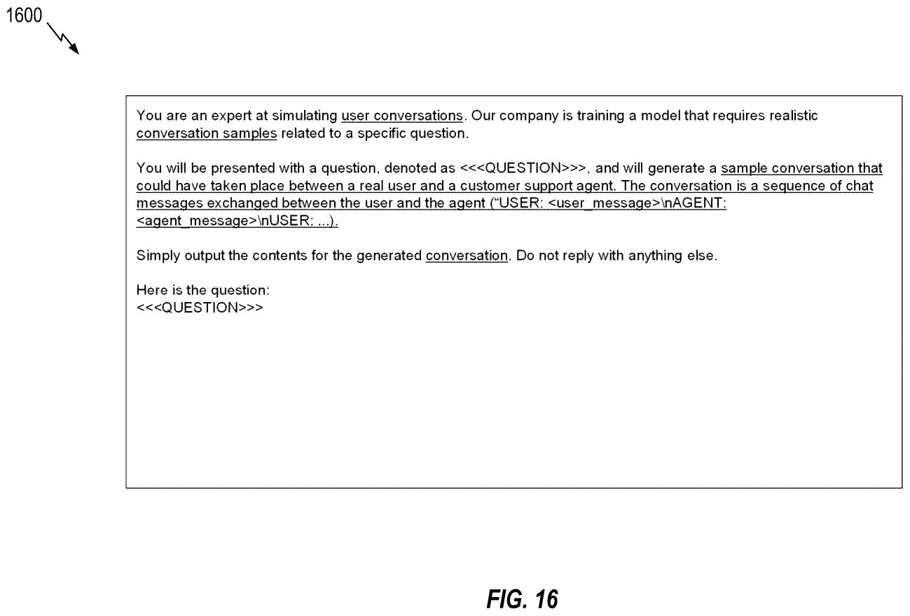

FIG. 16 depicts a prompt 1600, as another example of a prompt for query generation. The prompt 1600 uses an input of a question (e.g., as generated based on the prompt 800 of FIG. 8, the prompt 900 of FIG. 9, or the prompt 1000 of FIG. 10) and is used for generating a synthetic query (e.g., as part of the two-step process depicted in FIG. 3B). The prompt 1600 is used to generate a synthetic query in the form of a conversation (e.g., a chat conversation). The prompt 1600 is an example of specifying a query type (e.g., other than an email), where the underlined portions of the prompt 1600 include changes relative to the prompt 1200 of FIG. 12.

As depicted in and described with respect to FIGS. 8-16, various combinations of information depicted in FIGS. 4A, 4B, and 4C may be included as part of a first prompt for question/summary generation (e.g., preprocessing) and as part of a second prompt for synthetic query generation (e.g., based on the generated question/summary), consistent with this disclosure. For example, such first prompt may be related to generating questions from a provided document or article, where the first prompt may correspond to the question generation prompt 400 of FIG. 4A or the summary generation prompt 412 of FIG. 4B. The second prompt may be related to generating the synthetic queries (e.g., emails or chats) based on the questions or summary generated based on the first prompt, where the second prompt may correspond to the query generation prompt 422 of FIG. 4C. The second prompt, without access to the source document or article, may improve the representativeness of a generated synthetic query as a realistic user query (e.g., from a user who would not have seen the document or article) when compared to generating a synthetic query in a one-step process (without the preprocessing described with respect to FIG. 2A). Other combinations of information may be included in the first prompt and/or the second prompt, consistent with this disclosure.

### Example Representation of a Generated Question or Synthetic Query

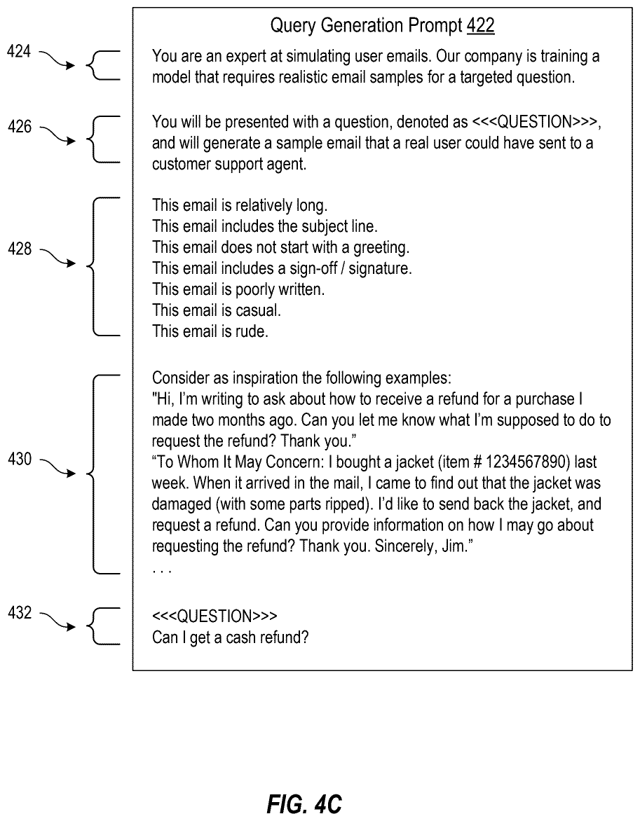

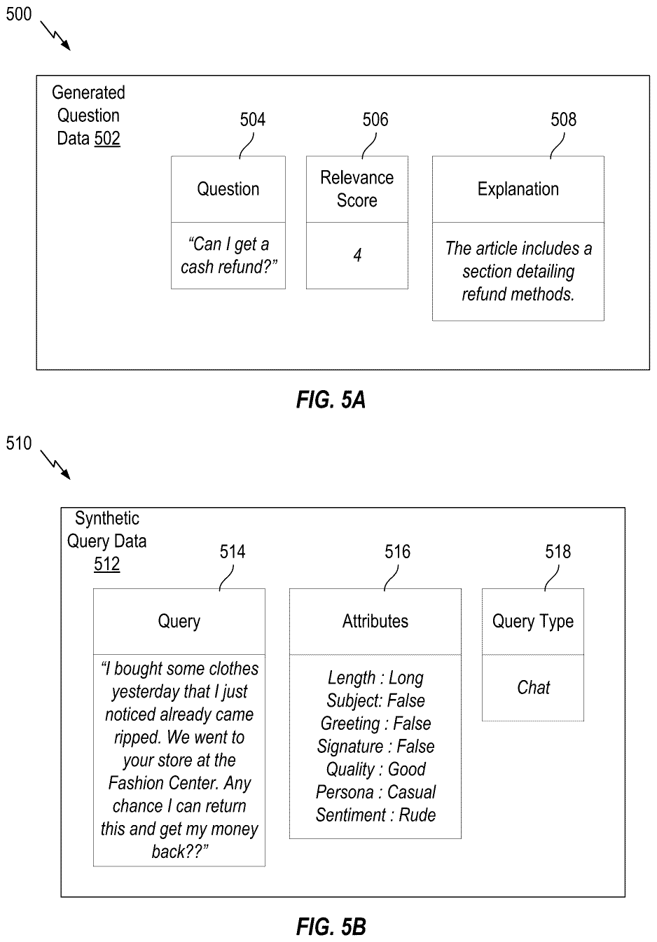

FIGS. 5A and 5B depict example representations 500, 510 representing generated question data 502 and generated synthetic query data 512, respectively.

The example representation 500 of FIG. 5A represents an example of generated question data 502, which includes a question 504, a relevance score 506, and an explanation 508. The generated question 504 may be generated as part of the preprocessing described with respect to FIG. 2A. These components of the generated question data 502 may correspond to the various parts of an output generated based on a question generation prompt, such as the question generation prompt 400 of FIG. 4A. The question 504 may correspond to the inferred questions 212 of FIG. 2A. The relevance score 506 and the explanation 508 may correspond to the relevance score and the explanation described with respect to steps 236 and 240 of FIG. 2A. Other examples including fewer, additional, or alternative components are possible consistent with this disclosure.

The example representation 510 of FIG. 5B represents an example of synthetic query data 512 (e.g., including a query 514 and one or more instances of metadata, such as attributes 516 and a query type 518) that may be generated in accordance with the process flow 200 described with respect to FIG. 2B. Other examples including fewer, additional, or alternative components are possible consistent with this disclosure.

As depicted in FIG. 5B, the synthetic query data 512 includes the query 514, the attributes 516, and the query type 518. These components of the synthetic query data 512 may correspond to various components of an output generated based on a query generation prompt, such as the query generation prompt 422 of FIG. 4C.

The query 514 includes the synthetic query that is generated.

The attributes 516 include attributes (e.g., a stylistic aspect, a semantic content, etc.) associated with the generated synthetic query (query 514). These attributes may correspond to the attributes described herein with reference to steps 222, 224, 226, 228, and 232 of the process flow 200 described with respect to FIG. 2B.

The query type 518 includes the query type of the generated synthetic query, for example, as specified in accordance with step 244 of the process flow 200 described with respect to FIG. 2B.

Other metadata (e.g., not shown in the depicted example representation 510 of FIG. 5B, such as other than the attributes 516 or the query type 518) may also be possible, for example, to be included as part of additional instances of metadata, consistent with this disclosure.

The example representations 500 and 510 are merely illustrations, for example, representing the different parts of the generated question data 502 and the synthetic query data 512. The generated question data 502 and the synthetic query data may be stored in any data structure or format as would be apparent to one of ordinary skill in the art, such as a JSON object or a tuple, or similar.

### Example Method of Generating Synthetic Queries to Train a Machine Learning Model

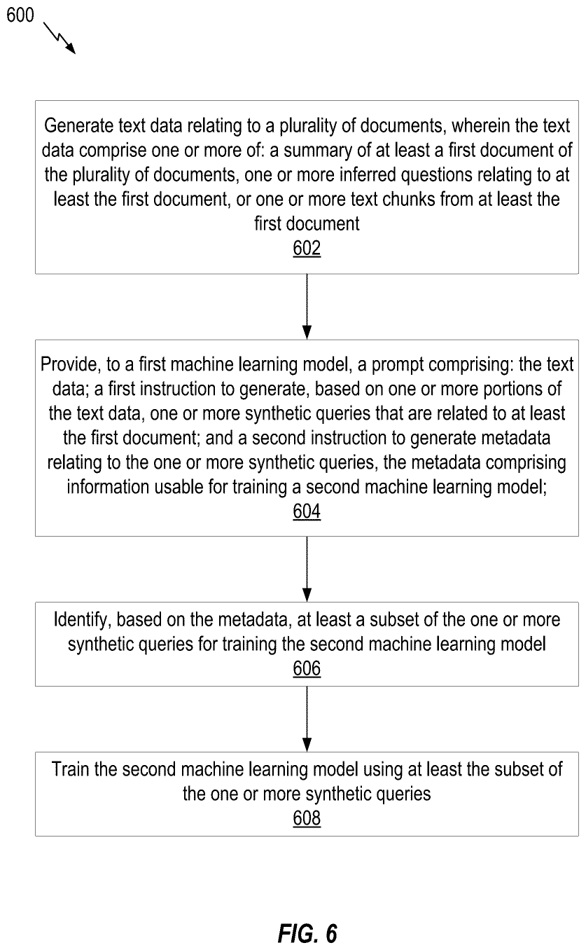

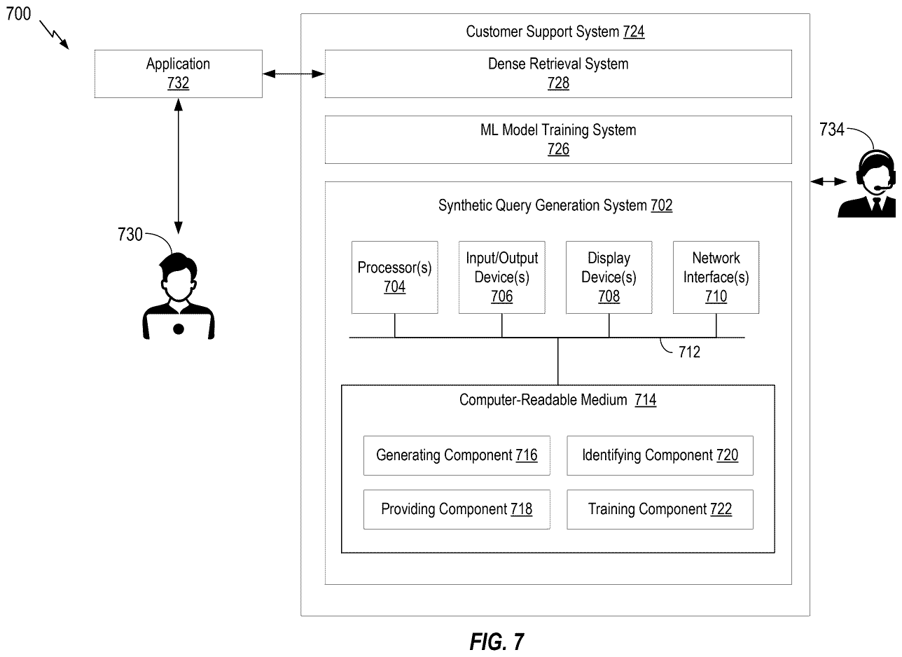

FIG. 6 depicts an example method 600 for generating a plurality of synthetic queries to train a machine learning model as a dense retrieval model. In one aspect, method 600 can be implemented by the system architecture 100 of FIG. 1 (e.g., including synthetic query generation system 106 and machine learning model training system 110) and/or processing system 700 of FIG. 7 (e.g., including synthetic query generation system 702 and machine learning model training system 726).

Method 600 starts at block 602 with generating text data relating to a plurality of documents, wherein the text data comprise one or more of: a summary of at least a first document of the plurality of documents, one or more inferred questions relating to at least the first document, or one or more text chunks from at least the first document. In some cases, the method 600 may be an example of a two-step process of generating synthetic queries as depicted in, for example, FIG. 3B. For example, block 602 may correspond to the first step of generating questions (e.g., by the question generator 308 of FIG. 3B).

Method 600 continues to block 604 with providing, to a first machine learning model, a prompt comprising: the text data; a first instruction to generate, based on one or more portions of the text data, one or more synthetic queries that are related to at least the first document; and a second instruction to generate metadata relating to the one or more synthetic queries, the metadata comprising information usable for training a second machine learning model. The first instruction may include an instruction to generate the one or more synthetic queries based on the one or more portions of the text data (e.g., to transform a question, such as an inferred question, into a synthetic query). As described herein, the instruction to generate the one more synthetic queries based on the one or more portions of the text data (e.g., the summaries, inferred questions, and/or text chunks generated at block 602) may result in more representative queries being generated (e.g., when compared to a one-step process of generating synthetic queries without a preprocessing step described with respect to FIG. 2A). Such two-step process avoids distorting the synthetic queries with overly specific details from the documents or articles (e.g., answers to the generated questions).

In certain aspects, the prompt further comprises one or more few-shot query examples, and the first instruction instructs the first machine learning model to generate the one or more synthetic queries further based on the one or more few-shot query examples.

In some aspects, the prompt further comprises one or more query attributes, and the first instruction instructs the first machine learning model to generate the one or more synthetic queries further based on the one or more query attributes. In certain cases, the one or more query attributes comprise at least one query attribute that is randomly selected from a set of predefined query attributes. In some cases, the one or more query attributes comprise at least one query attribute that is selected from a set of predefined query attributes based on an attribute distribution of a plurality of historical queries. In some examples, the set of predefined query attributes may be requested for each synthetic query (e.g., where the prompt may (e.g., always) request the same attributes (e.g., preset attributes). In some examples, the prompt may sample different attributes (e.g., dynamic attributes) for more diverse outputs. The sampling method may be a random distribution over generic sets of attributes, or a custom distribution for specific use cases. The custom distribution may be learned from historical data related to the specific use cases, or may be assumed based on target industry/domain (e.g., as may be stored as metadata). The benefit of considering both historical data (e.g., real tickets) and metadata (e.g., a target industry such as banking industry) is that the historical data may be specific while using prior volume and proper usage permissions, while the metadata do not use such prior volume and proper usage permissions. The metadata may still be more specific than random sampling over all possibilities (e.g., for banking, a polite tone may be more likely than an impolite tone).

In certain aspects, the text data comprises the one or more inferred questions, where generating the text data comprises generating at least one inferred question of the one or more inferred questions with a relevance score relating to the one inferred question.

In some aspects, the text data comprises the one or more inferred questions, where generating the text data comprises generating at least one inferred question of the one or more inferred questions with an explanation relating to the one inferred question, and the explanation comprises one or more steps performed by the first machine learning model to generate the one inferred question.

In certain aspects, the prompt further comprises one or more query types in which the one or more synthetic queries are to be generated.

In some aspects, the metadata comprise one or more of: one or more query attributes, or a query type.

Method 600 continues to block 606 with identifying, based on the metadata, at least a subset of the one or more synthetic queries for training the second machine learning model.

Method 600 continues to block 608 with training the second machine learning model using at least the subset of the one or more synthetic queries.

In certain aspects, training the second machine learning model comprises training the second machine learning model to function as a dense retrieval model for matching one or more documents of the plurality of documents to a customer request, the one or more documents associated with a target customer base. The target customer base may correspond to, for example, a customer base (e.g., a specific customer base) of a customer support system.

In some aspects, training the second machine learning model comprises training the second machine learning model using one or more portions of historical query data.

The solution described herein (e.g., with reference to or related to the method 600 of FIG. 6) combines the best qualities of both synthetic queries and real-ticket-based information, in that it can use information related to the real customer requests or tickets without relying completely on the real-ticket-based information. For example, the method 600 generates synthetic queries for training a machine learning model for information retrieval, along with metadata that can introduce real-ticket-based information (e.g., related to attributes associated with the synthetic queries). Thus, the technical challenges associated with using real customer requests or tickets for training the machine learning model (e.g., a potential bias related to suggested help center documents) are mitigated. The solution described herein provides improvements for synthetic query generation in two ways. Firstly, the two-step process described herein results in more representative queries being generated (e.g., when compared to a one-step process), where the two-step process described herein is designed to avoid distorting the synthetic queries with overly specific details from the documents or articles. Secondly, the sample of attributes may result in more diverse queries being generated (e.g., when compared to using preset attributes). For example, certain attributes may be selected based on attribute distributions learned from historical queries from specific use cases, specific industries, or similar.

Note that FIG. 6 is just one example of a method, and other methods including fewer, additional, or alternative operations are possible consistent with this disclosure.

### Example Processing System

FIG. 7 depicts an example processing system 700 configured to perform various aspects described herein, including, for example, process flow 200 as described above with respect to FIGS. 2A and 2B and method 600 as described above with respect to FIG. 6.

The processing system 700 includes synthetic query generation system 702. The synthetic query generation system 702 may be implemented in an electronic device configured to execute computer-executable instructions, such as those derived from compiled computer code, including, for example, desktop computers, tablet computers, server computers, cloud-based processing devices, and others.

In the depicted example, the synthetic query generation system 702 includes one or more processors 704, one or more input/output devices 706, one or more display devices 708, one or more network interfaces 710 through which the synthetic query generation system 702 is connected to one or more networks (e.g., a local network, an intranet, the Internet, or any other group of processing systems communicatively connected to each other), and one or more computer-readable mediums 714. In the depicted example, the aforementioned components are coupled by a bus 712, which may generally be configured for data exchange amongst the components described herein. The bus 712 may be representative of multiple buses, while only one is depicted for simplicity.

The one or more processors 704 are generally configured to retrieve and execute instructions stored in one or more memories, including local memories like the computer-readable mediums 714, as well as remote memories and data stores. More generally, the bus 712 may be configured to transmit programming instructions and application data among the processors 704, the display devices 708, the network interfaces 710, and/or the computer-readable mediums 714. In certain aspects, the processors 704 may be representative of one or more central processing units (CPUs), graphics processing units (GPUs), tensor processing units (TPUs), accelerators, and other processing devices.

The input/output devices 706 may include any device, mechanism, system, interactive display, and/or various other hardware and software components for communicating information between the synthetic query generation system 702 and a user or operator of the synthetic query generation system 702, such as a customer support agent 734. For example, the input/output devices 706 may include input hardware, such as a keyboard, touch screen, button, microphone, speaker, and/or other device for receiving inputs from a user and sending outputs to a user.

The display devices 708 may generally include any sort of device configured to display data, information, graphics, user interface elements, and the like to a user. For example, the display devices 708 may include internal and external displays such as an internal display of a tablet computer or an external display for a server computer or a projector. The display devices 708 may further include displays for devices, such as augmented, virtual, and/or extended reality devices. In various aspects, the display devices 708 may be configured to display a graphical user interface.

The network interfaces 710 provide the synthetic query generation system 702 with access to external networks and thereby to external processing systems. The network interfaces 710 can generally be any hardware and/or software capable of transmitting and/or receiving data via a wired or wireless network connection. Accordingly, the network interfaces 710 may include a communication transceiver for sending and/or receiving any wired and/or wireless communication.

The computer-readable mediums 714 may be a volatile memory, such as a random access memory (RAM), or a nonvolatile memory, such as nonvolatile random access memory (NVRAM), or the like. In this example, the computer-readable mediums 714 include at least a generating component 716, a providing component 718, an identifying component 720, and a training component 722.

In certain aspects, the generating component 716 is configured to perform functions, such as generating text data relating to a plurality of documents. For example, the generating component 716 may perform the function of generating text data relating to a plurality of documents as described herein with reference to block 602 of FIG. 6.

In certain aspects, the providing component 718 is configured to perform functions, such as providing, to a first machine learning model, a prompt. For example, the providing component 718 may perform the function of providing, to a first machine learning model, a prompt as described herein with reference to block 604 of FIG. 6.

In certain aspects, the identifying component 720 is configured to perform functions, such as identifying, based on the metadata, at least a subset of the one or more synthetic queries for training the second machine learning model. For example, the identifying component 720 may perform the function of identifying, based on the metadata, at least a subset of the one or more synthetic queries for training the second machine learning model as described herein with reference to block 606 of FIG. 6.

In certain aspects, the training component 722 is configured to perform functions, such as training the second machine learning model using at least the subset of the one or more synthetic queries. For example, the training component 722 may perform the function of training the second machine learning model using at least the subset of the one or more synthetic queries as described herein with reference to block 608 of FIG. 6.

Generally, one or more end users 730 may interact with a customer support system 724 through, for example, one or more client computer systems. The customer support system 724, including the synthetic query generation system 702, a machine learning model training system 726, and a dense retrieval system 728, may be provided by an organization, such as a commercial enterprise, to enable the end users 730 to access a plurality of support services in regards to, for example, a product or service offered by the organization, by an application 732. Generally, the application 732 may be any sort of application, such as a web application, native application, mobile device application, smart device application, or the like.

In various aspects, the end users 730 may utilize the application 732 to access the customer support system 724 to provide, for example, a customer support request. In that regard, the application 732 may provide the means for supporting a communication channel such as, for example, an email or an online chat. In various aspects, the customer support request may be processed, for example, by a customer support agent 734, who interacts with the end user 730 through the customer support system 724. In that regard, the application 732 provides the means for the end user 730 to interact with the customer support agent 734 to resolve the customer support request. In some aspects, the application 732 itself may be available on or through a product to which the customer support request is related, thus providing a direct access to the customer support system 724 through the application 732 itself without requiring an additional intermediary tool or method to access the customer support system 724. In some aspects, the application 732 may not be associated with the customer support system 724, but instead may be provided via a device that provides the intermediary means for the end user 730 to access the customer support system 724.

The synthetic query generation system 702 may generate the synthetic queries to be used by the machine learning model training system 726 to train a machine learning model to function as a dense retrieval model (e.g., as part of the dense retrieval system 728). The customer support agent 734 may interact with the customer support system 724 (e.g., the dense retrieval system 728), which retrieves one or more documents related to the customer support request, to identify the one or more documents related to the customer support request to provide to the end user 730 (e.g., through the application 732). In some cases, the customer support agent 734 may be a bot that interacts with the customer support system 724 (e.g., the dense retrieval system 728) to (e.g., automatically) provide one or more documents related to a customer support request in response to receiving the customer support request.

FIG. 7 is just one example of a processing environment consistent with aspects described herein, and other processing systems having additional, alternative, or fewer components are possible consistent with this disclosure.

### Example Clauses

Implementation examples are described in the following numbered clauses:
Clause 1: A method, comprising: generating text data relating to a plurality of documents, wherein the text data comprise one or more of: a summary of at least a first document of the plurality of documents, one or more inferred questions relating to at least the first document, or one or more text chunks from at least the first document; providing, to a first machine learning model, a prompt comprising: the text data; a first instruction to generate, based on one or more portions of the text data, one or more synthetic queries that are related to at least the first document; and a second instruction to generate metadata relating to the one or more synthetic queries, the metadata comprising information usable for training a second machine learning model; identifying, based on the metadata, at least a subset of the one or more synthetic queries for training the second machine learning model; and training the second machine learning model using at least the subset of the one or more synthetic queries.
Clause 2: The method of Clause 1, wherein the prompt further comprises one or more few-shot query examples, and the first instruction instructs the first machine learning model to generate the one or more synthetic queries further based on the one or more few-shot query examples.
Clause 3: The method in accordance with any one of Clauses 1-2, wherein the prompt further comprises one or more query attributes, and the first instruction instructs the first machine learning model to generate the one or more synthetic queries further based on the one or more query attributes.
Clause 4: The method of Clause 3, wherein the one or more query attributes comprise at least one query attribute that is randomly selected from a set of predefined query attributes.
Clause 5: The method in accordance with any one of Clauses 3-4, wherein the one or more query attributes comprise at least one query attribute that is selected from a set of predefined query attributes based on an attribute distribution of a plurality of historical queries.
Clause 6: The method in accordance with any one of Clauses 1-5, wherein the text data comprises the one or more inferred questions, wherein generating the text data comprises generating at least one inferred question of the one or more inferred questions with a relevance score relating to the one inferred question.
Clause 7: The method in accordance with any one of Clauses 1-6, wherein: the text data comprises the one or more inferred questions, wherein generating the text data comprises generating at least one inferred question of the one or more inferred questions with an explanation relating to the one inferred question, and the explanation comprises one or more steps performed by the first machine learning model to generate the one inferred question.
Clause 8: The method in accordance with any one of Clauses 1-7, wherein the prompt further comprises one or more query types in which the one or more synthetic queries are to be generated.
Clause 9: The method in accordance with any one of Clauses 1-8, wherein the metadata comprise one or more of: one or more query attributes, or a query type.
Clause 10: The method in accordance with any one of Clauses 1-9, wherein training the second machine learning model comprises training the second machine learning model to function as a dense retrieval model for matching one or more documents of the plurality of documents to a customer request, the one or more documents associated with a target customer base.
Clause 11: The method in accordance with any one of Clauses 1-10, wherein training the second machine learning model comprises training the second machine learning model using one or more portions of historical query data.
Clause 12: A processing system, comprising: a memory comprising computer-executable instructions; and a processor configured to execute the computer-executable instructions and cause the processing system to perform a method in accordance with any one of Clauses 1-11.
Clause 13: A processing system, comprising means for performing a method in accordance with any one of Clauses 1-11.
Clause 14: A non-transitory computer-readable medium storing program code for causing a processing system to perform the steps of any one of Clauses 1-11.
Clause 15: A computer program product embodied on a computer-readable storage medium comprising code for performing a method in accordance with any one of Clauses 1-11.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
generating text data relating to a plurality of documents, wherein the text data comprise one or more of:
a summary of at least a first document of the plurality of documents,
one or more inferred questions relating to at least the first document, or
one or more text chunks from at least the first document;
providing, to a first machine learning model, a prompt comprising:
the text data;
a first instruction to generate, based on one or more portions of the text data, one or more synthetic queries that are related to at least the first document; and
a second instruction to generate metadata relating to the one or more synthetic queries, the metadata comprising information usable for training a second machine learning model;
identifying, based on the metadata, at least a subset of the one or more synthetic queries for training the second machine learning model; and
training the second machine learning model using at least the subset of the one or more synthetic queries.

2. The method of claim 1, wherein the prompt further comprises one or more few-shot query examples, and the first instruction instructs the first machine learning model to generate the one or more synthetic queries further based on the one or more few-shot query examples.

3. The method of claim 1, wherein the prompt further comprises one or more query attributes, and the first instruction instructs the first machine learning model to generate the one or more synthetic queries further based on the one or more query attributes.

4. The method of claim 3, wherein the one or more query attributes comprise at least one query attribute that is randomly selected from a set of predefined query attributes.

5. The method of claim 3, wherein the one or more query attributes comprise at least one query attribute that is selected from a set of predefined query attributes based on an attribute distribution of a plurality of historical queries.

6. The method of claim 1, wherein the text data comprises the one or more inferred questions, wherein generating the text data comprises generating at least one inferred question of the one or more inferred questions with a relevance score relating to the one inferred question.

7. The method of claim 1, wherein:
the text data comprises the one or more inferred questions, wherein generating the text data comprises generating at least one inferred question of the one or more inferred questions with an explanation relating to the one inferred question, and
the explanation comprises one or more steps performed by the first machine learning model to generate the one inferred question.

8. The method of claim 1, wherein the prompt further comprises one or more query types in which the one or more synthetic queries are to be generated.

9. The method of claim 1, wherein the metadata comprise one or more of:
one or more query attributes, or
a query type.

10. The method of claim 1, wherein training the second machine learning model comprises training the second machine learning model to function as a dense retrieval model for matching one or more documents of the plurality of documents to a customer request, the one or more documents associated with a target customer base.

11. The method of claim 1, wherein training the second machine learning model comprises training the second machine learning model using one or more portions of historical query data.

12. A processing system, comprising: one or more memories comprising computer-executable instructions; and one or more processors configured to execute the computer-executable instructions and cause the processing system to:
generate text data relating to a plurality of documents, wherein the text data comprise one or more of:
a summary of at least a first document of the plurality of documents,
one or more inferred questions relating to at least the first document, or
one or more text chunks from at least the first document;
provide, to a first machine learning model, a prompt comprising:
the text data;
a first instruction to generate, based on one or more portions of the text data, one or more synthetic queries that are related to at least the first document; and
a second instruction to generate metadata relating to the one or more synthetic queries, the metadata comprising information usable for training a second machine learning model;
identify, based on the metadata, at least a subset of the one or more synthetic queries for training the second machine learning model; and
train the second machine learning model using at least the subset of the one or more synthetic queries.

13. The processing system of claim 12, wherein the prompt further comprises one or more few-shot query examples, and the first instruction instructs the first machine learning model to generate the one or more synthetic queries further based on the one or more few-shot query examples.

14. The processing system of claim 12, wherein the prompt further comprises one or more query attributes, and the first instruction instructs the first machine learning model to generate the one or more synthetic queries further based on the one or more query attributes.

15. The processing system of claim 14, wherein the one or more query attributes comprise at least one query attribute that is randomly selected from a set of predefined query attributes.

16. The processing system of claim 14, wherein the one or more query attributes comprise at least one query attribute that is selected from a set of predefined query attributes based on an attribute distribution of a plurality of historical queries.

17. The processing system of claim 12, wherein the text data comprises the one or more inferred questions, wherein to generate the text data comprises to generate at least one inferred question of the one or more inferred questions with a relevance score relating to the one inferred question.

18. The processing system of claim 12, wherein:
the text data comprises the one or more inferred questions, wherein to generate the text data comprises to generate at least one inferred question of the one or more inferred questions with an explanation relating to the one inferred question, and
the explanation comprises one or more steps performed by the first machine learning model to generate the one inferred question.

19. The processing system of claim 12, wherein the metadata comprise one or more of:
one or more query attributes, or
a query type.

20. The processing system of claim 12, wherein to cause the processing system to train the second machine learning model, the one or more processors are configured to train the second machine learning model to function as a dense retrieval model for matching one or more documents of the plurality of documents to a customer request, the one or more documents associated with a target customer base.
